(19) United States
(12) Patent Application Publication
(10) Pub. No.: US 2017/0096935 A1
(43) Pub. Date: Apr. 6, 2017

(54) Method and Apparatus for Cleaning a Gas Engine

(71) Applicant: Chinook End-Stage Recycling Limited, Nottinghamshire (GB)

(72) Inventors: Rifat Al Chalabi, Nottinghamshire (GB); Ophneil Henry Perry, Nottinghamshire (GB); Ke Li, Nottinghamshire (GB)

(73) Assignee: Chinook End-Stage Recycling Limited, Nottinghamshire (GB)

(21) Appl. No.: 15/315,957

(22) PCT Filed: Jun. 2, 2015
(86) PCT No.: PCT/GB2015/051603

§ 371 Date: Dec. 2, 2016

(30) Foreign Application Priority Data
Jun. 2, 2014 (GB) 1409762.0

(51) Int. Cl. F02B 77/04; F02M 25/12

(52) U.S. Cl. CPC F02B 77/04; F02M 25/12

(57) ABSTRACT

The present invention relates to a method of cleaning a surface within a gas engine, the method comprising: passing ozone through an inlet to the engine and over the surface, reacting the ozone with any organic contaminants on the surface, and removing the reacted contaminants and any residual ozone from an outlet from the engine as a gaseous exhaust. The method is particularly suited to cleaning sensitive or delicate apparatus such as pre-combustion portions of a gas engine.

The present invention relates to a method of cleaning a gas engine or part thereof and an apparatus for performing the method.

Waste-to-energy systems represent an important and growing source of electrical energy as well as capacity for processing recycling and waste and recovering valuable materials. While incinerators are well-known, important developments are being made in systems that involve the gasification of organic wastes to produce combustible gas. Such gasification systems can also be used to process recyclable scrap in order for re-use and sale.

Existing gasifiers employ high temperature ovens to pyrolyse and/or gasify organic materials in the waste or recyclable material and produce synthesis gas (syngas), a combination of mostly carbon monoxide (CO) and hydrogen gas (H₂). Due to the inherent impurity of the waste or recyclable material being processed, a high level of impurities and contaminants are present in the syngas, including but not limited to soot, ash, tars, and other heavier hydrocarbons. Even with comprehensive cleaning processes, low volumes of particulate matter and other contaminants remain in the syngas.

Combusting ‘dirty’ syngas from waste processing plants i.e. syngas with low levels of contamination, is known to cause issues over the lifetime of the combustion apparatus. Due to the high volumes of syngas being processed, the plant apparatus gradually becomes contaminated with the tar and hydrocarbon impurities in the syngas. One particular issue is with the inlet/fuel-feeding equipment becoming contaminated. This includes inlet/feed lines, filters, valves & regulators, metal surfaces etc.

The contaminant build up is very slow, being deposited on the surfaces of the apparatus gradually over time. The deposits negatively impact the plant efficiency, and may ultimately lead to the plant becoming non-operational should it be allowed to continue unchecked.

Known processes for cleaning the plant apparatus include burning off the deposits and chemical cleaning. Burning off the deposits, i.e. combusting the deposits in the presence of O₂, is undesirable for sensitive equipment and apparatus such as the pre-combustion portion, since it requires high temperatures (approximately 300-400° C.) which may damage the equipment. Chemical cleaning, on the other hand, is sometimes preferable since it does not require the high temperatures used in burning off the deposits. However, it can be cost prohibitive, especially in high-volume situations that would require frequent cleaning cycles be run, as well as creating a further issue of disposal of large volumes of contaminated chemicals. A downside of both methods is that they require the plant to be shutdown in order for the cleaning cycle to be completed, which may take hours or even days and result in a loss in productivity and a drop in plant efficiency.

It is to be understood that the pre-combustion portion is intended to mean any part of a gas engine or any connected or associated apparatus prior to the combustion portion. The pre-combustion portion typically comprises any of: fuel inlets, filters, valves, regulators, ducts, pipes, surfaces or other components.

It is therefore desirable to reduce or limit the impact of contaminants on plants using syngas from waste material sources or any other source of “dirty gas”.

It is an aim of the present invention to provide an apparatus and method to mitigate or ameliorate at least one of the problems of the prior art, or provide a useful alternative.

According to a first aspect of the invention, there is provided a method of cleaning a surface within a gas engine, the method comprising the steps of
passing ozone through an inlet to the engine and over the surface,
reacting the ozone with any organic contaminants on the surface, and
removing the reacted contaminants and any residual ozone from an outlet from the engine as a gaseous exhaust.

Ozone is a powerful oxidant and it will be understood that any organic residues, tars or ash material will react to form CO and/or CO₂ which will form part of the gaseous exhaust.

The method may comprise an additional step of recirculating through the engine at least a portion of the gaseous exhaust.

The method may comprise a step of monitoring the composition of the gaseous exhaust and varying the portion of recirculated gas in response to the monitored composition. In one example, the ozone concentration is monitored and the portion of recirculated gas varied to ensure the ozone concentration is maintained within a predetermined range. In another example, the concentration of reacted contaminants such as CO or CO₂ is monitored and the portion of recirculated gas varied to maintain the concentration of the contaminants at a pre-determined level. In a further example the level of oxygen is monitored.

The method may be carried out for a predetermined period, for example at least 1, at least 2, at least 4, at least 6, at least 8, at least 10, at least 12, at least 18, at least 24, at least 36, or at least 48 hours. Alternatively, where the composition of the exhaust is monitored, the method may be carried out until the contaminants in the exhaust fall below a predetermined value, thereby indicating that the surface is clean. Alternatively, the method may be carried out until the total carbon level (CO/CO₂) remains constant, thereby indicating that no further oxidation is taking place. It will be understood that in the latter cases, shutdown time is minimised as the method is only carried out for the length of time sufficient to remove the contaminants.

The reaction step is conveniently conducted at a temperature of 50° C. or less, of 45° C. or less, of 35° C. or less, or of 25° C. or less. The reaction step is conveniently conducted at a temperature of 15° C. or more or 20° C. or more.

Since ozone is reactive at relatively low temperatures, the method is particularly suited to the cleaning of the pre-combustion parts of a gas engine which will be easily damaged at the temperatures required for burning off any organic residues.

It will be understood that the ozone will be diluted by a carrier gas, for example air or oxygen. A suitable ozone concentration is less than 10%, or less than 8%. In some embodiments the ozone concentration is more than 2% or more than 4%. In a series of embodiments the ozone concentration is from 5 vol % to 7 vol % (all percentages by volume). Typically an ozone generator will be used to generate the ozone, the ozone being pumped into the inlet through a suitable conduit.

According to a second aspect of the invention, there is provided a cleaning apparatus for performing the method described above comprising

an ozone source,

a supply conduit for connection to an inlet of a gas engine

an exhaust conduit for connection to an outlet from a gas engine

The ozone source will conveniently be an ozone generator. The ozone generator may utilise any one or more of: a corona discharge, UV light, plasma and/or electrolysis or other method of generating ozone. The ozone generator may comprise a corona discharge tube. Alternatively, the ozone generator may comprise a dielectric barrier discharge.

The cleaning apparatus may comprise a recirculation conduit connecting the supply and exhaust conduits to permit exhaust gases to be recirculated. In order to control the proportion of gases entering the recirculation conduit a variable speed fan may be provided in the recirculation conduit. Alternatively or in addition, a valve may be provided between the exhaust conduit and the recirculation conduit.

The cleaning apparatus may comprise a sensor for monitoring the exhaust gases. The sensor may monitor the gas composition. The sensor may, for example, measure the amount and/or concentration of organic molecules in the exhaust and/or the amount and/or concentration of ozone in the gases. The sensor may comprise a Flame Ionisation Detector (FID). Where a recirculation conduit is provided, a controller for the fan and/or valve may be provided which is operatively connected to the sensor. The controller opens and closes the valve and/or changes the speed of the fan in order to control the proportion of exhaust entering the recirculation loop in response to the sensor output.

Alternatively or in addition, the controller may be operatively connected to the ozone source such that the amount of ozone or rate of flow of ozone can be adjusted according to the output of the sensor.

The invention will now be described by reference to the following drawings wherein:

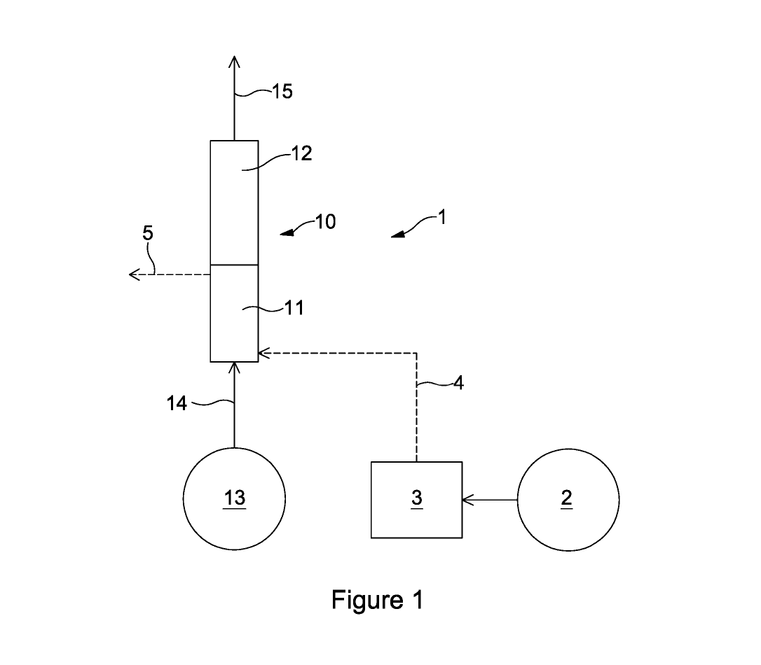

FIG. 1 is a schematic diagram of a first embodiment of the invention;

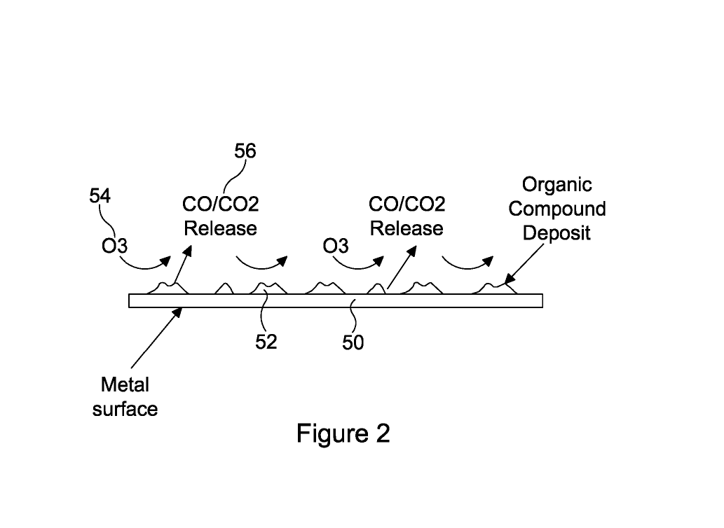

FIG. 2 is a diagram showing the cleaning mechanism in operation;

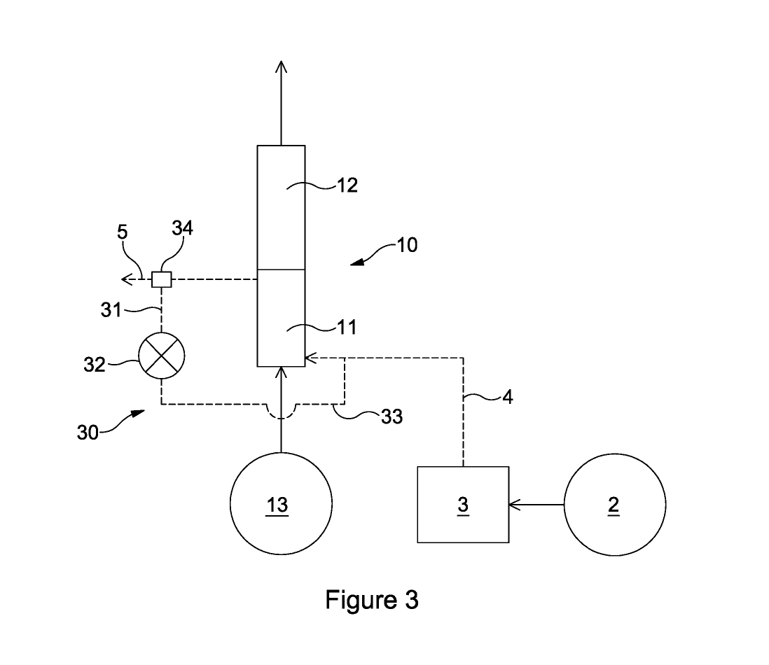

FIG. 3 is a schematic diagram of a second embodiment of the invention;

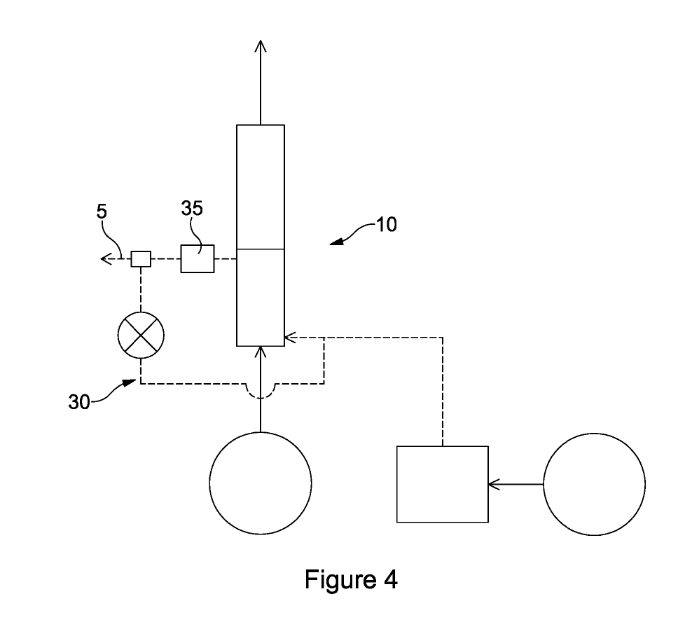

FIG. 4 is a schematic diagram of a third embodiment of the invention; and

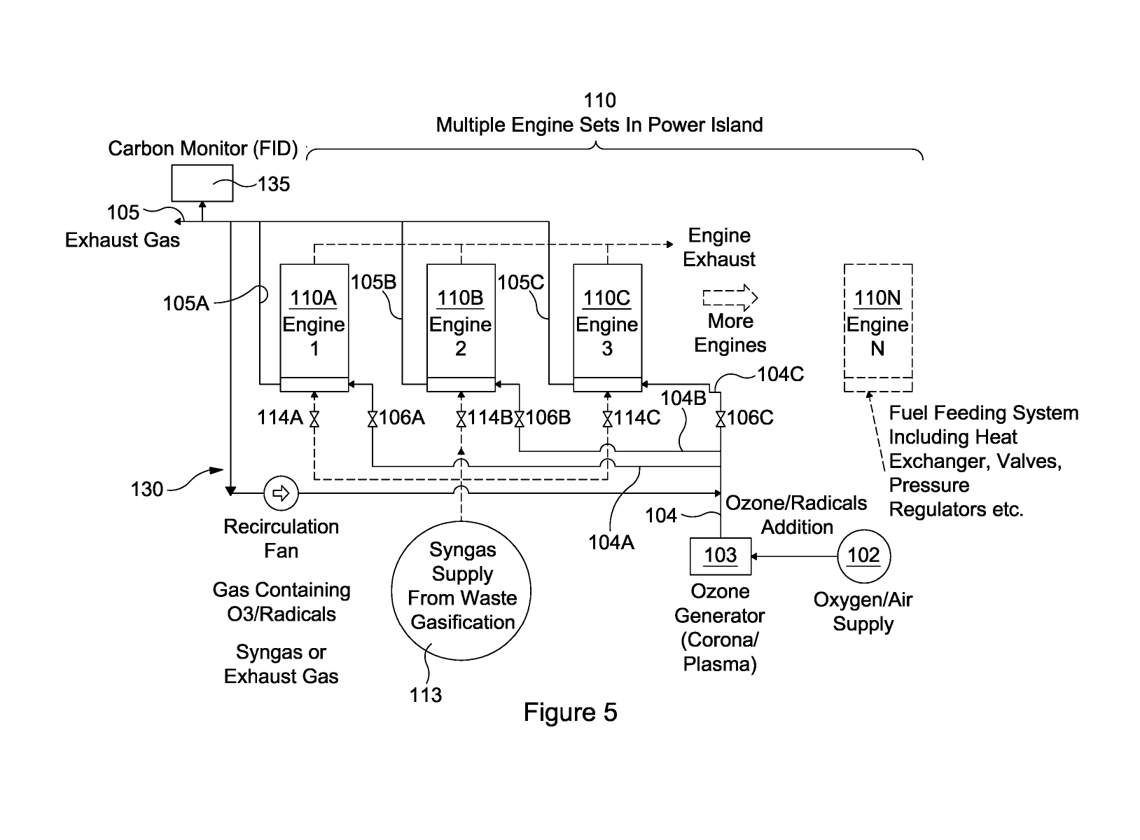

FIG. 5 is a schematic diagram of a fourth embodiment of the invention.

Turning now to FIG. 1, there is shown a schematic diagram of a first embodiment of the invention. Shown is a conventional gas engine 10 with a pre-combustion portion 11 and a combustion portion 12. The gas engine is provided with a gas supply 13, which supplies gas (in this case syngas) via a pipe 14 to the pre-combustion portion 11. The gas then passes through the pre-combustion portion 11 into the combustion portion 12 where it is combusted to produce useful energy, e.g. to drive a generator (not shown). The exhaust gases generated in the combustion portion then exit the combustion portion 12 via the gas engine exhaust duct 15, where they may be exhausted or further processed, for example in a heat recovery apparatus (not shown).

The cleaning apparatus 1 has an oxygen source 2 which supplies oxygen to an ozone generator 3. The ozone generator 3 converts oxygen, into ozone (O₃). The supply conduit 4 transports the ozone from the ozone generator 3 to a first part of the pre-combustion portion 11 of the gas engine 10 through an inlet. The pre-combustion portion 11 has an exhaust conduit 5 for exhausting the waste gases produced within the pre-combustion portion 11 during the cleaning cycle.

Turning to FIG. 2, the diagram explains the process in operation within the pre-combustion portion 11 of the gas engine 10. During operation of the gas engine 10, small amounts of organic contaminants 52 are deposited on the surfaces 50 within the pre-combustion portion 11. Due to the low concentration of contaminants in the syngas, the contaminants form discrete deposits 52. During the cleaning cycle ozone 54 is introduced into the contaminated pre-combustion portion 11. Since the ozone 54 is a powerful oxidising agent, it readily oxidises the organic deposits 52 forming cleaning cycle exhaust gases 56, typically carbon monoxide and/or carbon dioxide. The cleaning cycle exhaust gases are then removed from the pre-combustion portion 11 by the flow of gases and are exhausted through the exhaust conduit 5. Preferably cleaning occurs before a continuous layer of deposit has been established. This can be determined visually or from the change in an operating parameter of the engine. For example, engines are typically provided with an inlet filter. A pressure drop on the downstream side of the filter is indicative of a build up of tar and the need for a cleaning cycle.

Referring now to both FIGS. 1 and 2, in use, the ozone generator 3 is able to produce a supply of ozone and other ions and radicals such as OH to be introduced into the pre-combustion portion. The ozone and other radicals are preferably kept in a moderately low concentration in order to fully oxidise the organic deposits 52 without causing oxidation and corrosion of the surfaces 50. This is achieved by either using an inert carrier gas or only partially reacting the oxygen from the oxygen source 2 so that the desired level of ozone is generated.

The residence time of the ozone and/or other radicals is selected in order to ensure that the ozone and/or other radicals have sufficient time to contact and react with the organic deposits 52. The residence time may also be limited to ensure that corrosion of the apparatus does not occur. The residence time can thereby be adjusted in order to adjust the desired efficiency of the cleaning. Since the lifetime of the reactive ozone and/or other radical is relatively short, the ozone generator can continuously supply ozone to ensure a desired concentration or range of ozone and/or other radicals.

In the cleaning cycle according to the invention, the gas engine is temporarily shut down and the cleaning cycle run. The cleaning cycle is typically relatively quick, between 3 and 24 hours depending on the level of contamination. The cleaning cycle is preferably run frequently, e.g. before the deposits of contaminants form a cohesive layer. As shown in FIG. 2, since the contaminants form discrete deposits, the surface area is maximised and thus the process is more efficient. The frequent running of the cleaning cycle also means that the deposit is easier to remove; with increased time the deposit has more chance to bond strongly with the surface it is contaminating.

The cleaning cycle described has a number of advantages over the cleaning mechanisms of the prior art.

The pre-combustion portion 11 of the gas engine 10 typically comprises components that are heat sensitive, or at least, are ill-suited to withstand the high temperatures required to burn off organic deposits in the presence of atmospheric oxygen (O₂). Since ozone is more reactive than O₂, it is possible to fully oxidise the organic deposits at much lower operating temperatures, typically between 15 to 50° C. Not only is this a desirable temperature range for preventing heat damage to the pre-combustion portion, it is also the temperature range wherein the ozone is at its most efficient. The gas engine 10 can therefore be completely cleaned without requiring harsh and expensive chemicals or high temperatures which could damage the pre-combustion portion 11.

Additionally, since the cleaning cycle is run frequently and at low levels of contamination, the cleaning process is completed quickly and the gas engine can be brought back into operation much quicker than if the engine was shut down and the contamination removed chemically or by burning it off.

Furthermore, since there is only a low level of contamination, the amount of waste gases generated, for example CO₂ from the oxidation of the organic materials, is kept to low levels. It is therefore possible to exhaust the waste gases without requiring significant or expensive post-processing.

Turning now to FIG. 3, there is shown a second embodiment of the invention wherein identical components will not be repeated. The gas engine 10 further comprises a recirculation mechanism 30. The recirculation mechanism comprises an exhaust valve 34, a first recirculation conduit 31, a fan 32 and a second recirculation conduit 33. The valve 34 is positioned in the exhaust conduit 5 and is operable to direct the gases exiting the gas engine 10 either along the exhaust conduit 5 (the exhaust position) or the first recirculation conduit 31 (the recirculation position). The valve 34 may also be configured to direct a portion of the gases down each conduit.

When the valve 34 is in the recirculation position, the gases are directed into the first recirculation conduit 31 which leads to the fan 32. The fan is operated in order to ensure a steady flow of gas around the circuit and into the second recirculation conduit 33. The second recirculation conduit supplies the gases back into the supply conduit 4.

The gas exiting the gas engine 10 is thus pumped back around and re-enters the gas engine.

The second embodiment provides a mechanism wherein the residence time of the ozone may be simply and accurately controlled to maximise efficiency. Since the cleaning is carried out by the ozone gas and other radicals being pumped through the pre-combustion portion, it is expected that not all of the ozone will react with the deposits. By recirculating the unreacted ozone round the system it has multiple chances to react with the organic deposits and thus is more likely to do so, increasing efficiency. Recirculation therefore means less ozone needs to be generated and lower concentrations of ozone can be used, reducing the cost of generation and reducing the likelihood of corrosion of the gas engine by the ozone.

Turning now to FIG. 4, there is shown a third embodiment of the invention which is identical to the FIG. 3 embodiment save for the provision of a sensor 35 to monitor the gases exiting the gas engine. The sensor 35 includes a flame ionisation detector (FID) and is configured to measure the presence of organic compounds in the exhaust gases. When the sensor detects the presence of organic compounds, for example the CO₂ generated in the cleaning cycle, it is clear that the levels of organic contaminants in the gas engine are decreasing. When no carbon is detected in the exhaust, it is clear that the cleaning cycle is complete and the cleaning cycle can be ended.

The sensor is operatively linked to the valve 34 by a computer (not shown) so that the recirculation mechanism can be operated in response to the carbon levels in the exhaust gas. When the carbon levels detected by the sensor are high, the valve is set to the exhaust position. When the carbon values are low the valve is set to the recirculation position to ensure that the ozone is being utilised efficiently. In another embodiment not shown, the sensor measures the level of ozone directly and the valve is set to the recirculation position when the level of ozone is high.

The computer system can configure either a batch process or a continuous process. In a batch process the ozone is pumped into the gas engine and recirculated until it has been used up. The gases are then exhausted and a new batch of ozone is pumped into the engine. These steps are repeated until no organic compounds are detected by the sensor and the cleaning cycle is ended. Alternatively, the process can be repeated until the carbon (i.e. CO and CO₂) concentration is “saturated”, that is reached a constant value indicating that no further oxidation is occurring. It will be understood that in this latter case, the ozone level must also be monitored to ensure that the constant carbon value is not due to complete consumption of the ozone. In a continuous process the valve is continuously adjusted to ensure that the gas being recirculated fits within a set of criteria, e.g. desired concentration levels.

Turning now to FIG. 5, there is shown a schematic diagram of a fourth embodiment of the invention.

The cleaning apparatus shown comprises an oxygen supply 102, an ozone generator 103 and a supply conduit 104. The cleaning apparatus also comprises an exhaust conduit 105, a sensor 135, and a recirculation apparatus 130. The cleaning apparatus 100 operates on the same principles as the cleaning apparatus 1 as described above and in FIGS. 1, 3 and 4.

The supply conduit 104 is configured to transport ozone from the ozone generator 103 to an array of gas engines 110. The array is shown to comprise three gas engines 110A, 110B, 110C, although the system may be configured in the same manner for any number of engines 110N in the array 110. The supply conduit 104 splits into three conduits 104A-C which in turn supply each gas engine 110A-C individually. Each conduit 104A-C is provided with an ozone supply valve 106A-C which is operable to allow gases to flow or to shut off the supply of ozone from ozone generator 103.

Each engine 110A-C is connected to the exhaust conduit 105 by respective exhaust conduits 105A-C. Thus the exhausted gases from each engine are combined into the same exhaust flow.

In use, the gas engines 110A-C are powered by syngas from the syngas supply 113.

When it is desired to perform a cleaning cycle on engine 110A, it is shut off from the syngas supply by syngas valves 114A and shut down. Gas engines 110B, 110C . . . 110N are unaffected and continue in normal operation.

The ozone supply valve 106A is then opened and ozone is provided to the pre-combustion portion of the gas engine 110A. The gases from the cleaning cycle exit the engine 110A via exhaust conduit 105A and enter exhaust conduit 105. The gas composition is monitored by the sensor 135 and the recirculation controlled depending on the levels of ozone and carbon dioxide in the exhaust. The gases are recirculated until the cleaning cycle is finished, typically when no more organic compounds are detected in the exhaust gases. The ozone supply valve 106A is closed, the syngas supply valve 114A re-opened and the engine 110A is restarted. When it is desired to perform a cleaning cycle on any of the other gas engines 110B,C . . . N in the array 110 the above process is repeated with the relevant changes made.

The cleaning apparatus for use with an array 110 of gas engines provides a mechanism wherein the output from the array and the required cleaning cycles can be easily optimised. It is possible to configure the system so that at least one of the gas engines is offline and undergoing a cleaning cycle at any particular time. Thus the output from the array is constant and unaffected by the requirement to clean the engines. One of the subsequent advantages is that it is not undesirable to shut down an engine in order to run a cleaning cycle, thus ensuring that the cleaning is run regularly and thus the engines do not suffer from a gradual decline in efficiency due to a build-up of contaminants within the pre-combustion portions.

Another advantage is that it is very simple to clean multiple engines simultaneously should it be necessary, for example, in response to a variation in the syngas. By alternating between engines, the pre-combustion portions can be efficiently cleaned before a cohesive or thick layer of contamination builds-up and the efficiency drops.

1. A method of cleaning a surface within a gas engine, the method comprising:
passing ozone through an inlet to the engine and over the surface,
reacting the ozone with any organic contaminants on the surface, and
removing the reacted contaminants and any residual ozone from an outlet from the engine as a gaseous exhaust.

2. The method of claim 1 comprise recirculating through the engine at least a portion of the gaseous exhaust.

3. The method of claim 2 comprising monitoring the composition of the gaseous exhaust and varying the portion of recirculated gas in response to the monitored composition.

4. The method of claim 3, wherein the ozone concentration is monitored.

5. The method of claim 3, wherein the concentration of reacted contaminants such as CO and/or CO2 is monitored.

6. The method of claim 3, wherein the level of oxygen is monitored.

7. The method of claim 1, wherein the method is carried out until the contaminants in the exhaust fall below a predetermined value or until the total carbon level (CO/CO2) remains constant.

8. The method of claim 1, wherein the reaction step is conducted at a temperature of 50° C. or less.

9. The method of claim 1, wherein the surface to be cleaned forms part of a pre-combustion part of a gas engine.

10. A cleaning apparatus for performing the method of claim 1 comprising:
an ozone source,
a supply conduit for connection to an inlet of a gas engine
an exhaust conduit for connection to an outlet from a gas engine

11. The apparatus of claim 10, wherein the ozone source is an ozone generator.

12. The apparatus of claim 10 additionally comprising a recirculation conduit connecting the supply and exhaust conduits to permit exhaust gases to be recirculated.

13. The apparatus of claim 12 additionally comprising a variable displacement fan positioned in or adjacent the recirculation conduit.

14. The apparatus of claim 12 additionally comprising a valve between the exhaust conduit and the recirculation conduit.

15. The apparatus of claim 10 additionally comprising at least one sensor for monitoring the exhaust gases.

16. The apparatus of claim 15 in which the at least one sensor is configured to measure at least one of:
(i) the concentration of organic molecules in the exhaust,
(ii) the concentration of ozone in the exhaust.
(iii) the concentration of oxygen in the exhaust.

17. The apparatus of claim 14 additionally comprising a controller for the fan and/or valve, when present, which is operatively connected to the sensor such that the proportion of exhaust entering the recirculation conduit is adjusted in response to the sensor output.

18. The apparatus of claim 10, wherein the controller is operatively connected to the ozone source such that the amount of ozone or rate of flow of ozone can be adjusted according to the output of the sensor.
